(19) United States
(12) Patent Application Publication
(10) Pub. No.: US 2025/0217135 A1
(43) Pub. Date: Jul. 3, 2025

(54) Intelligent Systems for Autogenerating Disseminated Virtual Environment Setup Using Parallel Mesh Oriented Logical Programming

(71) Applicant: Bank of America Corporation, Charlotte, NC (US)

(72) Inventors: Bala Bhaskar Yerramsetti, Hyderabad (IN); Durga Prasad Kutthumolu, Hyderabad (IN)

(21) Appl. No.: 18/401,891

(22) Filed: Jan. 2, 2024

(51) Int. Cl. G06F 8/71; G06F 8/10

(52) U.S. Cl. CPC G06F 8/71; G06F 8/10

(57) ABSTRACT

Arrangements for remotely developing an application are provided. A computing platform may receive a request to build an application. The computing platform may receive the request through an API gateway. The computing platform may use a smart contract to identify a first node as a parent node and a plurality of nodes as child nodes. The computing platform may direct the child nodes to transmit virtual copies of dependency packages to the parent node. The parent node may build the application after receiving the dependency packages. The computing platform may detect that the application has been successfully built and may automatically publish the application at an enterprise server.

### BACKGROUND

Aspects of the disclosure relate to developing an application, in which the development may depend on specific files or packages of files, known as dependencies. Dependency may generally include relationships between software components where one component relies on the other to function. For example, if an application relies on a library to perform any given function, the application depends on that library. Currently, developers may need to access certain dependency information (e.g., files and/or packages) in order to develop and build an application. This may require the dependency information to be locally stored by the developer, which may use local disc space, be time consuming, and further may consume network bandwidth and network resources. Additionally, if multiple developers are involved in the development of an application or multiple applications, even more space and resources are consumed. Accordingly, it may be advantageous to identify more effective and efficient methods for developing an application.

### SUMMARY

Aspects of the disclosure provide effective, efficient, scalable, and convenient solutions that address and overcome the technical problems associated with developing an application without locally storing dependency information necessary to build the application. In accordance with one or more aspects of the disclosure, a computing platform with at least one processor, a communication interface communicatively coupled to the at least one processor, and memory storing computer-readable instructions may receive, from a user device, a request to build an application. The computing platform may access, at a first node and based on the request to build the application, a first package corresponding to the application. The computing platform may identify dependency information in the first package, in which the dependency information may indicate a plurality of dependency packages the first node requires to build the application. The computing platform may identify, using a smart contract that corresponds to the dependency information, a plurality of nodes that contain the plurality of dependency packages. The computing platform may establish a connection between the first node and the plurality of nodes. The computing platform may send one or more commands to the plurality of nodes, that when received by the plurality of nodes, may direct the plurality of nodes to send virtual copies of the dependency packages to the first node. The computing platform may receive, by the first node, the dependency packages. The computing platform may execute, by the first node, the request to build the application, which may include building the application. The computing platform may detect that the application was successfully built. The computing platform may, based on detecting that the application was successfully built, automatically publish the application to an enterprise server that the user device may access.

In one or more instances, the computing platform may send, to the user device, a notification indicating that the application was successfully built and one or more commands directing the user device to display the notification, which may cause the user device to display the notification. In one or more examples, the request may be received by the computing platform through an application programming interface (API) gateway.

In one or more instances, the computing platform may generate the smart contract based on relationships between the first package at the first node and the dependency packages at the plurality of nodes. In one or more instances, the computing platform may detect missing dependency packages at one or more of the plurality of nodes.

In one or more examples, the first node may be a parent node and the plurality of nodes may be child nodes. In one or more instances, the computing platform may determine that the first node is the parent node based on information in the request to build the application indicating the first package at the first node is a primary software component of the application.

In one or more examples, the computing platform may demote the first node to a child node. The computing platform may promote a second node of the plurality of nodes to be the parent node. The computing platform may dynamically reconfigure the relationships between the first node, the second node, and a remainder of the plurality of nodes based on the demoting and promoting.

In one or more instances, the demoting may be based on the first node not exceeding a computing resource threshold required to support a future request. In one or more examples, the promoting may be based on the second node exceeding a computing resource threshold required to support a future request.

In one or more instances, the computing platform may update the smart contract based on the reconfiguring of the relationships between the first node, the second node, and the remainder of the plurality of nodes. In one or more examples, the computing platform may use the second node to execute a second request from the user device, which may include building a second application at the second node.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1C depict an illustrative computing environment for implementing an intelligent system for autogenerating a disseminated virtual environment setup using parallel mesh oriented logical programming in accordance with one or more example embodiments;

FIGS. 2A-2F depict an illustrative event sequence for implementing an intelligent system for autogenerating a disseminated virtual environment setup using parallel mesh oriented logical programming in accordance with one or more example embodiments;

FIG. 3 depicts an illustrative method for implementing an intelligent system for autogenerating a disseminated virtual environment setup using parallel mesh oriented logical programming in accordance with one or more example embodiments; and

FIG. 4 depicts an illustrative graphical user interface for implementing an intelligent system for autogenerating a disseminated virtual environment setup using parallel mesh oriented logical programming in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to developing an application without locally storing dependency information necessary to build the application. An application and its development may depend on specific versions of libraries of underlying software, known as dependencies. Currently, developers, such as user interface (UI) developers, may need to get certain files or packages, such as package manager files, to their local drives for the development of each project, which they may be getting from a repository, such as a network attached storage (NAS) repository. This may use local disc space and may be time consuming, and further may consume a high amount of network bandwidth and network resources. Further, the files or packages might not be required to be stored in local devices after the development is complete.

Accordingly, described herein is a distributed parallel mesh, in which all files and their dependencies may be placed in a centralized repository. A connection may be made to the repository to obtain a reference to a main module that may contain a file or package, which may be communicated internally with other modules for any kind of dependencies. Therefore, the package modules might not be downloaded to local drives, which may save local disc space and network resources. Further, mesh modules may be virtually communicated between each of the dependencies from the repository and may make a single module connection to the developer's machine. Therefore, not all dependent modules may be required to download in the developer's machine which may save memory and network bandwidth, and may boost performance.

Accordingly, a core system may first receive a virtual environmental project. Then the core system may analyze the content and may auto-generate and validate relevant packages in reference to their environmental set up. Next, the system may logically generate scripts and/or images to install a node package manager in a distributed parallel mesh, which may handle an infinite number of requests at the same time interval. These scripts may be intelligent enough to detect the real time content and may keep modulating internal logic in a distributed parallel mode. With the distributed parallel mesh based logical concept, the system may simultaneously interact with other nodes to share and receive the relevant files to build the batch or container image scripts. Additionally, for each node execution in the distributed parallel mesh, the nodes may have a predefined smart contract, which may check any node having a data conflict with another node using the smart contract, which may contain an encoding of that serializable parallel schedule that may cause a node to run without any interruption. Accordingly, by executing smart contract code in parallel across multiple nodes, the network may process a large number of transactions simultaneously and may handle higher volumes of traffic. The use of smart contracts in a parallel mesh network may help to increase the speed, security, and efficiency of transactions on the blockchain, and further may reduce the need for intermediaries and improve the transparency of the process. Additionally, if any node package is not available in the repository then the developers may be notified.

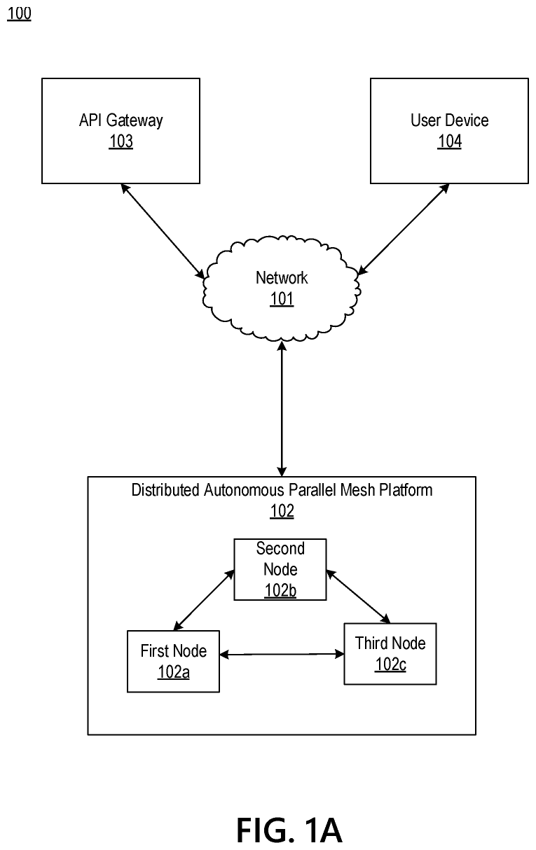

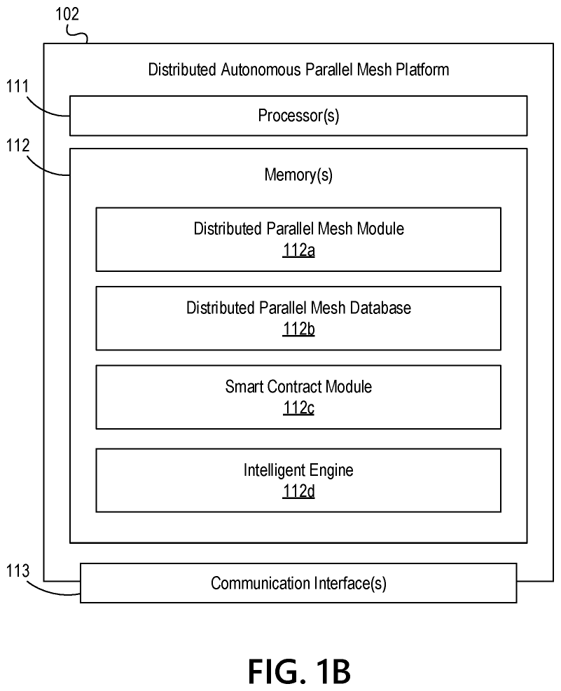

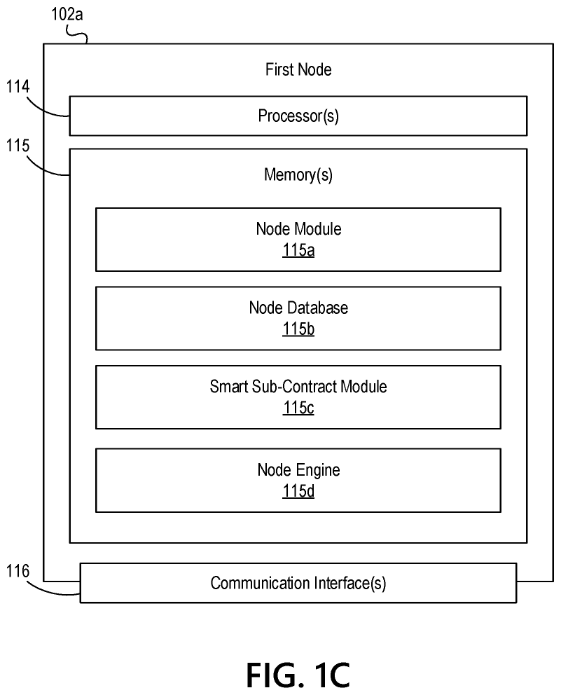

FIGS. 1A-1C depict an illustrative computing environment for implementing an intelligent system for autogenerating a disseminated virtual environment setup using parallel mesh oriented logical programming in accordance with one or more example embodiments. Referring to FIG. 1A, computing environment 100 may include one or more computer systems. For example, computing environment 100 may include a distributed autonomous parallel mesh platform 102, an application programming interface (API) gateway 103, and a user device 104. As described further below, distributed autonomous parallel mesh platform 102 may be a computer system that includes one or more computing devices (e.g., servers, server blades, or the like) and/or other computer components (e.g., processors, memories, communication interfaces) that may be used to autogenerate a disseminated virtual environment setup using parallel mesh oriented logical programming. In some instances, distributed autonomous parallel mesh platform 102 may remotely build an application without requiring a developer to locally store dependency information (such as a dependency package and/or other information) the application requires in order to be built, thereby saving local memory resources and network bandwidth. In some instances, distributed autonomous parallel mesh platform 102 may include and/or be connected to a server, such as an enterprise server, that may be used to publish an application that was successfully built. Distributed autonomous parallel mesh platform 102 may also be configured to receive information from API gateway 103, such as, for example, a request to build an application, and/or other information as described herein.

For example, distributed autonomous parallel mesh platform 102 may include a mesh of nodes configured to communicated with each other, transmit and receive information, such as, for example, virtual copies of dependency packages, build an application, and/or the like. For example, the distributed autonomous parallel mesh platform 102 may include a first node 102a, a second node 102b, and a third node 102c, which may represent software components and/or contain packages, such as a user-interface or front-end package, a back-end package, a queue package, and/or other components/packages. Although distributed autonomous parallel mesh platform 102 includes a three-node configuration, distributed autonomous parallel mesh platform 102 may be configured to include a mesh of any number of nodes in a variety of configurations without departing from the scope of the disclosure. By including a multi-node configuration, the distributed autonomous parallel mesh platform 102 may process and/or otherwise execute requests in parallel by distributing resources and/or tasks between nodes.

In some instances, each of first node 102a, second node 102b, and third node 102c may include dependency information that indicates dependencies, such as, for example, files, libraries, packages containing files and/or libraries, and the like. For example, first node 102a may include a first package (such as, for example, a user-interface or front-end package, a back-end package, a queue package, and/or other packages). Second node 102b may similarly include a second package, and third node 102c may similarly include a third package. Each of the packages at either of first node 102a, second node 102b, and/or third node 102c may depend on packages at other nodes. For example, the first package at first node 102a may depend on the second package at second node 102b and/or the third package at third node 103c. In a multi-node configuration, any node in a mesh of nodes may represent a particular software component and/or contain a package that depends on other packages at other nodes, creating a web of interrelated dependencies/dependency packages that may be used by distributed autonomous parallel mesh platform 102 to perform the functions described herein.

In some instances, each of first node 102a, second node 102b, and third node 102c may be directed by the distributed autonomous parallel mesh platform 102 to transmit and/or receive virtual copies of dependency packages from/to each other, in order that a particular node may have the necessary dependency packages from the other nodes in order to successfully build an application.

In some instances, one or more of first node 102a, second node 102b, and/or third node 102c may be configured as a parent node. For example, first node 102a may be configured as a parent node. Further, second node 102b and third node 102c may be configured as child nodes (e.g., child nodes of parent node 102a). In some instances, the distributed autonomous parallel mesh platform 102 may initially set a node as a parent node. In some instances, a node may be set as a parent node based on information in a request from the user device 104. In some instances, API gateway 103 may identify a node to be the parent node.

Additionally or alternatively, a child node may be promoted to a parent node. Additionally or alternatively, a parent node may be demoted to a child node. In some instances, distributed autonomous parallel mesh platform 102 may direct the child nodes, such as, for example, second node 102b and third node 102c to transmit virtual copies of dependency packages indicated by the dependency information, to first node 102a, the parent node. In this manner, the parent node, e.g., first node 102a, may use the dependency packages to build an application based on a request from user device 104.

API gateway 103 may be or include one or more computing devices (e.g., servers, server blades, or the like) and/or computer components (e.g., processors, memories, communication interfaces, and/or other components). API gateway 103 may be a data-plane entry point for API calls that represent client requests to target applications and services. API gateway 103 may act as a single entry point for all backend services that simplifies development, deployment and management of application development for developers. API gateway 103 may perform request-based processing based on policies, including authorization, access control, routing, and/or other processing. API gateway 103 may further be configured to receive requests from user device 104 (such as a request to build an application, and/or other requests), send a request from user device 104 to distributed autonomous parallel mesh platform 102, receive notifications from distributed autonomous parallel mesh platform 102 (such as a notification that an application was successfully built, and/or other notifications), send notifications to user device 104, and/or perform other actions. Additionally or alternatively, API gateway 103 may receive multiple requests from multiple user devices.

In some instances, API gateway 103 may receive, transmit, and/or send information from/to distributed autonomous parallel mesh platform 102/user device 104. In some instances, API gateway may include and/or be connected to a server, such as an enterprise server. Although illustrated as a single device, any number of data sources may provide API information without departing from the scope of the disclosure.

User device 104 may be a laptop computer, desktop computer, mobile device, tablet, smartphone, and/or other device, which may host, run, or otherwise request that an application be developed or built. In some instances, user device 104 may be a user computing device that is used by an individual. In some instances, user device 104 may be an enterprise computing device that is used by an administrator to host, run, or otherwise request that an application be developed or built. In some instances, user device 104 may be configured to display one or more user interfaces (e.g., interfaces depicting a notification that an application has been successfully built and/or has been published, or the like). Although only a single user device 104 is depicted, this is for illustrative purposes only, and any number of user devices may be implemented in the environment 100 without departing from the scope of the disclosure.

Computing environment 100 also may include one or more networks, which may interconnect distributed autonomous parallel mesh platform 102, API gateway 103, and user device 104. For example, computing environment 100 may include a network 101 (which may interconnect, e.g., distributed autonomous parallel mesh platform 102, API gateway 103, user device 104, and/or other computing devices).

In one or more arrangements, distributed autonomous parallel mesh platform 102, API gateway 103, and user device 104 may be any type of computing device capable of sending and/or receiving requests and processing the requests accordingly. For example, distributed autonomous parallel mesh platform 102, API gateway 103, and user device 104, and/or the other systems included in computing environment 100 may, in some instances, be and/or include servers, such as an enterprise server (for, e.g., publishing an application, and/or performing other functions), server computers, desktop computers, laptop computers, tablet computers, smart phones, or the like that may include one or more processors, memories, communication interfaces, storage devices, and/or other components. In some instances, the distributed autonomous parallel mesh platform 102 may support a multi-cloud infrastructure. As noted above, and as illustrated in greater detail below, any and/or all of distributed autonomous parallel mesh platform 102, API gateway 103, and user device 104 may, in some instances, be special-purpose computing devices configured to perform specific functions.

Referring to FIG. 1B, distributed autonomous parallel mesh platform 102 may include one or more processors 111, memory 112, and communication interface 113. A data bus may interconnect processor 111, memory 112, and communication interface 113. Communication interface 113 may be a network interface configured to support communication between distributed autonomous parallel mesh platform 102 and one or more networks (e.g., network 101, or the like). Memory 112 may include one or more program modules having instructions that when executed by processor 111 cause distributed autonomous parallel mesh platform 102 to perform one or more functions described herein and/or one or more databases that may store and/or otherwise maintain information which may be used by such program modules and/or processor 111. In some instances, the one or more program modules and/or databases may be stored by and/or maintained in different memory units of distributed autonomous parallel mesh platform 102 and/or by different computing devices that may form and/or otherwise make up distributed autonomous parallel mesh platform 102. For example, memory 112 may have, host, store, and/or include distributed parallel mesh module 112a, distributed parallel mesh database 112b, smart contract module 112c, and/or intelligent engine 112d.

Distributed parallel mesh module 112a may have instructions that direct and/or cause distributed autonomous parallel mesh platform 102 to process and/or execute a request from user device 104 by directing nodes, such as first node 102a, second node 102b, and/or third node 102c to transmit and/or receive virtual copies of dependency packages using a smart contract, and/or perform other functions, as discussed in greater detail below. Distributed parallel mesh database 112b may store information used by the distributed parallel mesh module 112a and/or distributed autonomous parallel mesh platform 102 and/or in performing other functions.

Smart contract module 112c may be used to generate, store, maintain, and/or dynamically update one or more smart contracts based on the node configuration within distributed autonomous parallel mesh platform 102, such as the configuration of first node 102a, second node 102b, and third node 102c shown in FIG. 1A. In some instances, the smart contract module 112c may identify and record relationships between nodes, such as, for example, relationships between first node 102a, second node 102b, and/or third node 102c in a blockchain. These relationships may be determined based on dependency information and/or dependency packages at either of first node 102a, second node 102b, and/or third node 102c.

For example, first node 102a may include a first package (such as e.g., a front-end package, back-end package, queue package, and/or other packages), that contains dependency information that indicates a second package (that may e.g., be located at second node 102b). Additionally or alternatively, the first package may further contain dependency information that indicates a third package (that may e.g., be located at third node 102c). The previously mentioned dependency information may be recorded in a smart contract that distributed autonomous parallel mesh platform may use to perform the functions described herein.

For example, based on a request to build an application at first node 102a, distributed autonomous parallel mesh platform 102 may use a smart contract that was generated by smart contract module 112c to direct second node 102b and/or third node 102c to transmit virtual copies of dependency packages, such as, for example, the second package and/or third package, to first node 102a, in order that first node 102a may have the necessary dependency packages for first node 102a to successfully build the application based on the request from user device 104.

In some instances, the previously mentioned relationships may be recorded in a blockchain. In using a smart contract to record the relationships on a blockchain, distributed autonomous parallel mesh platform 102 may take advantage of the technical benefits of the blockchain, such as, for example, greater speed and efficiency, trust and transparency, security, and accuracy and immutability. Further, in using a smart contract on a blockchain, distributed autonomous parallel mesh platform 102 may process multiple requests from multiple user devices simultaneously, and may process the requests in parallel and dynamically update the smart contract while maintaining an accurate record of events taking place throughout any type of node configuration within distributed autonomous parallel mesh platform 102.

Intelligent engine 112d may be used by distributed autonomous parallel mesh platform 102 and/or distributed parallel mesh module 112a to process requests from a user device 104, direct one or more child nodes to transmit virtual copies of dependency packages to a parent node, detect missing dependency packages at the one or more child nodes, promote a child node to a parent node, demote a parent node to a child node, and/or perform other methods described herein.

Referring to FIG. 1C, one example first node 102a is shown. The first node 102a may include one or more processors 114, memory 115, and communication interface 116. A data bus may interconnect processor 114, memory 115, and communication interface 116. Communication interface 116 may be a network interface configured to support communication between first node 102a, second node 102b, third node 102c, and/or distributed autonomous parallel mesh platform 102. Memory 115 may include one or more program modules having instructions that when executed by processor 114 cause first node 102a to perform one or more functions described herein and/or one or more databases that may store and/or otherwise maintain information which may be used by such program modules and/or processor 114. In some instances, the one or more program modules and/or databases may be stored by and/or maintained in different memory units of first node 102a and/or by different computing devices that may form and/or otherwise make up first node 102a. For example, memory 115 may have, host, store, and/or include node module 115a, node database 115b, smart sub-contract module 115c, and/or node engine 115d. Although FIG. 1C is described with reference to first node 102a, second node 102b and/or third node 102c may be configured to have equivalent or similar features without departing from the scope of the disclosure.

Node module 115a may have instructions that direct and/or cause first node 102a to build an application, receive virtual copies of dependency packages from second node 102b and/or third node 102c, receive commands from distributed autonomous parallel mesh platform 102, and/or perform other functions, as discussed in greater detail below. Node database 115b may store information used by the node module 112a and/or first node 102a, such as, for example, packages, files, and/or libraries (for use in building an application and the like) and/or in performing other functions. For example, the node database 115b of first node 102a may store a first package, (e.g., a front-end package, a back-end package, a queue package, and/or other packages). Second node 102b may similarly store a second package and third node 102c may similarly store a third package using equivalent node databases.

Smart sub-contract module 115c may be used to generate, store, maintain, and/or dynamically updated one or more smart sub-contracts based on relationships first node, second node, and/or third node, such as relationships between dependency information across nodes, similar to the primary smart contract generated by the smart contract module 112c of distributed autonomous parallel mesh platform 102. For example, first node 102a may use the smart sub-contract module 115c to generate a smart sub-contract that records dependency information specifically related to first node 102a's dependencies. Second node 102b and third node 102c may similarly generate smart sub-contracts that record corresponding dependencies.

In some instances, the smart sub-contract generated by smart sub-contract module 115c may be part of the primary smart contract generated by smart contract module 112c, and could represent a block on a larger blockchain. In some instances, smart sub-contract module 115c may access the primary smart contract that was generated by smart contract module 112c. In some instances, the smart sub-contract may be dynamically reconfigured based on the primary smart contract being modified and/or otherwise updated. Maintaining a separate smart sub-contract provides greater flexibility and security when performing the functions described herein.

Node Engine 115d may be used by first node 102a and/or node module 115a to build an application, request dependency information and/or dependency packages, detect missing dependency packages at one or more child nodes, determine that a new node can be added to the node configuration, and/or perform other methods described herein.

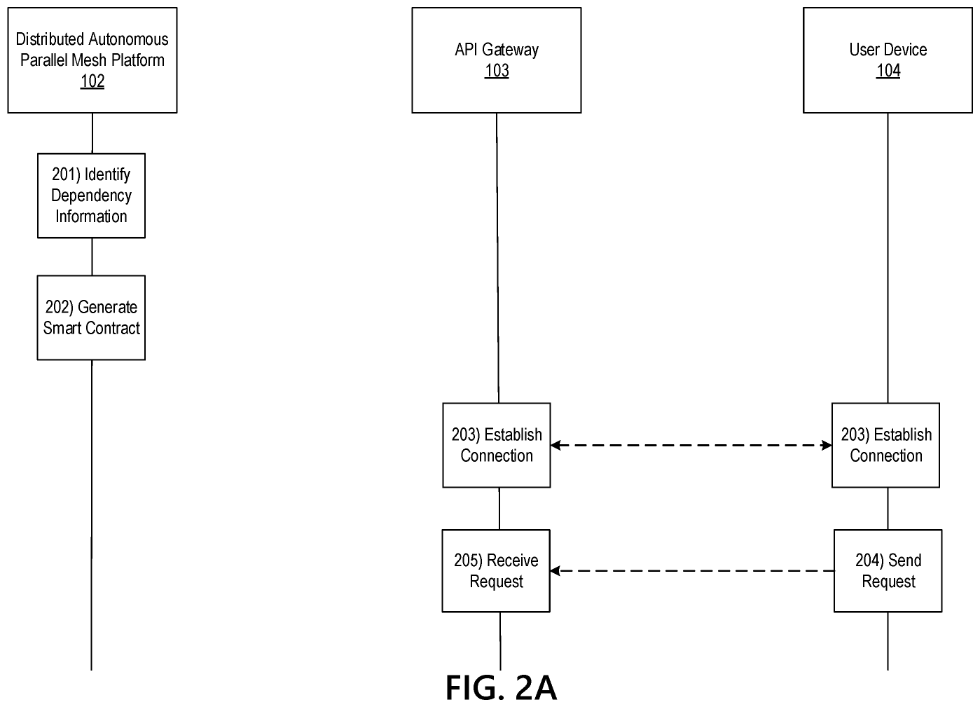

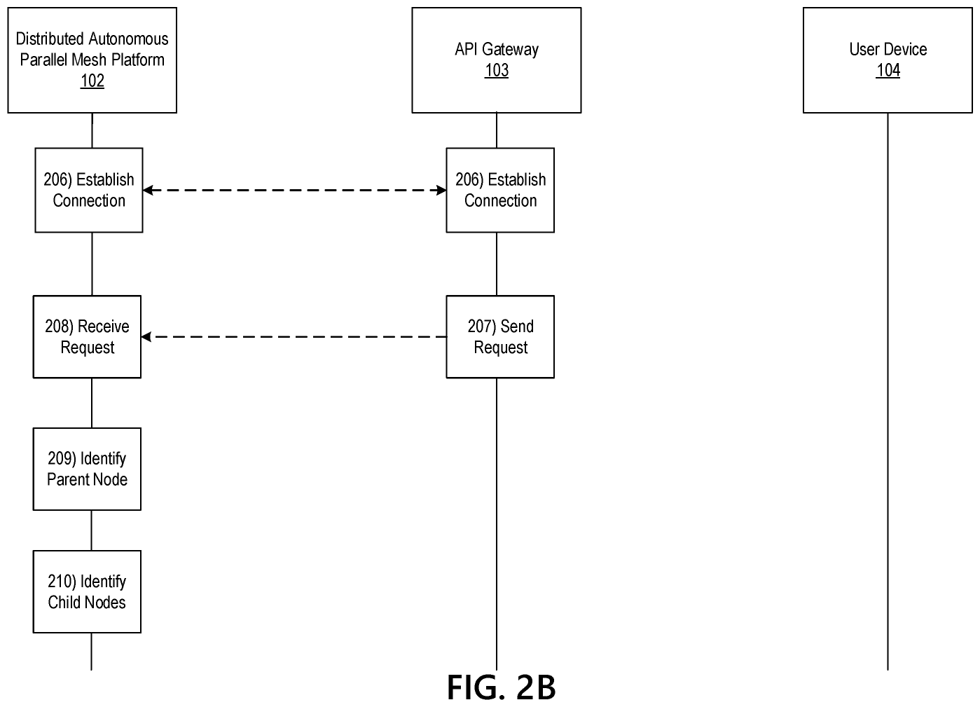

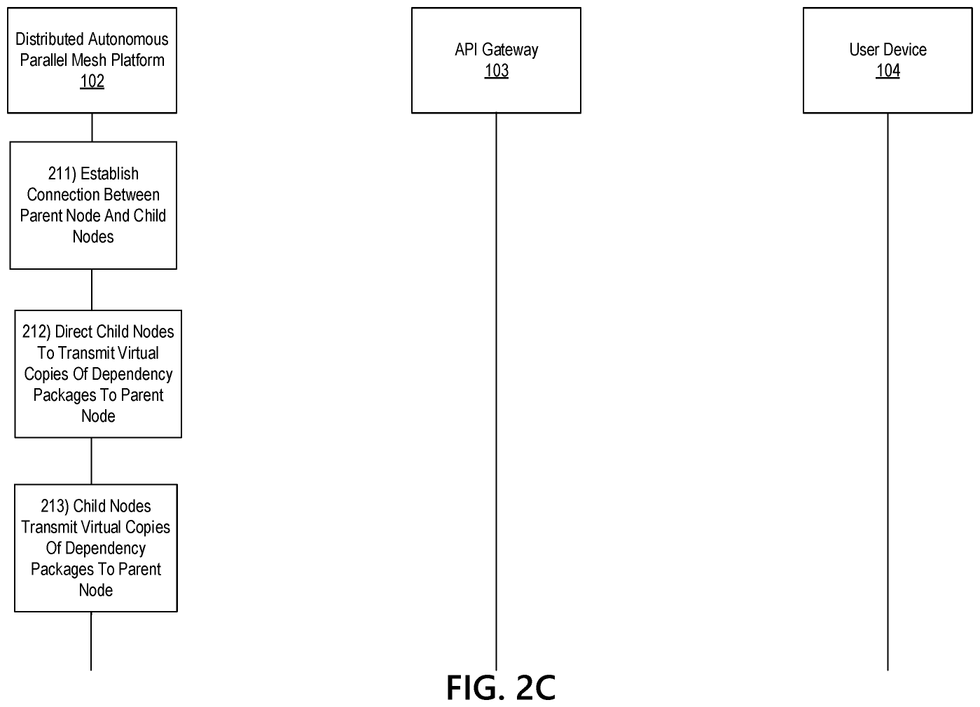

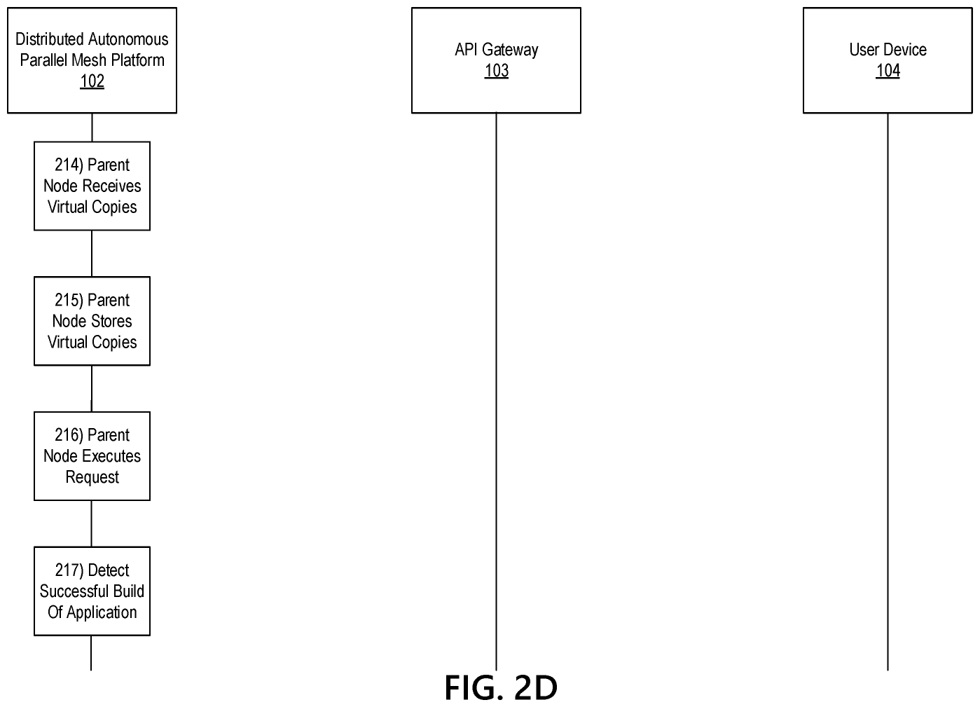

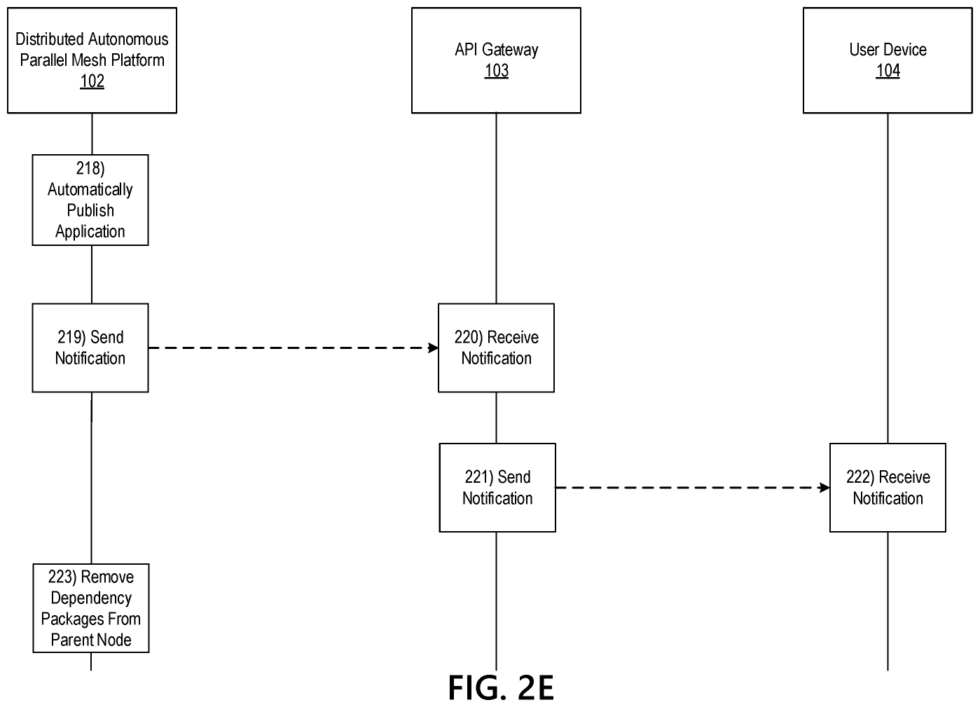

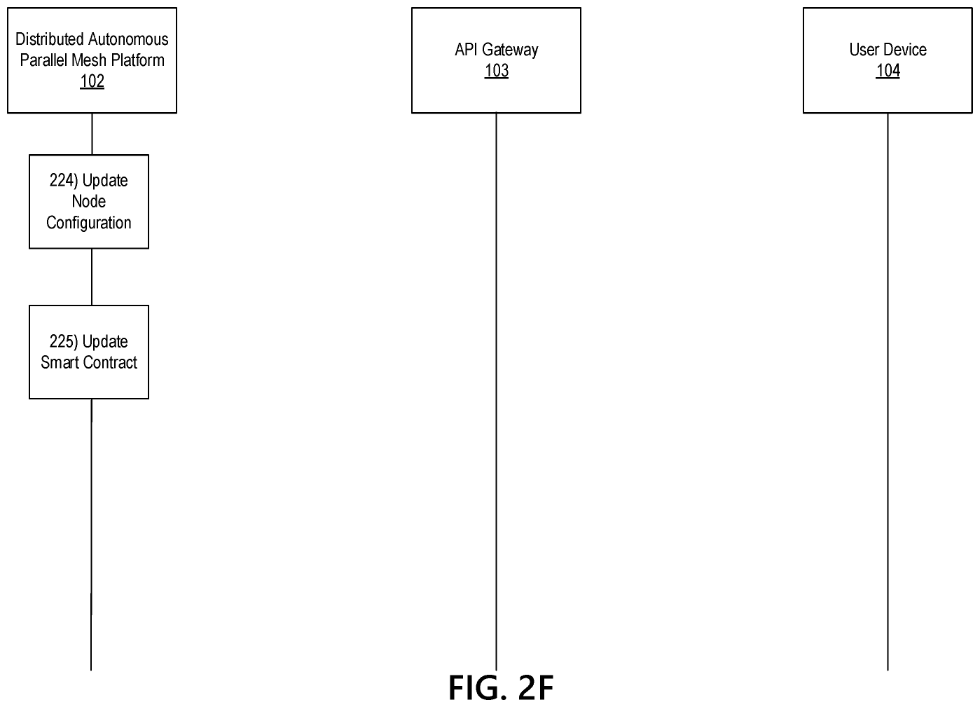

FIGS. 2A-2F depict an illustrative event sequence for implementing an intelligent system for autogenerating a disseminated virtual environment setup using parallel mesh oriented logical programming in accordance with one or more example embodiments. Referring to FIG. 2A, at step 201, distributed autonomous parallel mesh platform 102 may identify dependency information based on a current node configuration at the distributed autonomous parallel mesh platform 102. For example, distributed autonomous parallel mesh platform 102 may include a current node configuration, such as, for example, a three-node configuration including first node 102a, second node 102b, and third node 102c. However, there may be a plurality of node configurations without departing from the scope of the disclosure.

In some instances, each of first node 102a, second node 102b, and/or third node 102c may represent and/or contain a software component/package. For example, first node 102a may include a first package (such as, for example, a user-interface or front-end package, a back-end package, a queue package, and/or other packages). Second node 102b may similarly include a second package, and third node 102c may similarly include a third package. In some instances, the first package may contain dependency information that indicates dependency packages may be located at second node 102b (e.g., the second package) and/or third node 102c (e.g., the third package). If, for example, first node 102a is directed by distributed autonomous parallel mesh platform 102 to build an application based on a request from user device 104, first node 102a may require the second package at the second node 102b and/or the third package at the third node 102c to build the application.

Therefore, distributed autonomous parallel mesh platform 102 may identify the various packages and/or dependency information in order to understand relationships between nodes, such as first node 102a, second node 102b, and third node 102c, and relationships between software components and/or packages, such as the first package, second package, and/or third package. In identifying the previously mentioned relationships, distributed autonomous parallel mesh platform 102 may generate a smart contract that may record those relationships in anticipation of executing a request from user device 104.

At step 202, distributed autonomous parallel mesh platform 102 may generate a smart contract. Distributed autonomous parallel mesh platform 102 may generate the smart contract using smart contract module 112c. For example, the smart contract may record and/or encode the node configuration of distributed autonomous parallel mesh platform 102, such as the three-node configuration of first node 102a, second node 102b, and third node 102c. The smart contract may further record the dependency information that was identified in step 201. In some instances, each of first node 102a, second node 102b, and/or third node 102c may generate a corresponding smart sub-contract that records the dependency information particular to that node.

In some instances, distributed autonomous parallel mesh platform 102 may use the smart contract to initialize one of first node 102a, second node 102b, or third node 102c as a parent node, as discussed in more detail in step 209. For example, distributed autonomous parallel mesh platform 102 may configure first node 102a as the parent node in order to prepare first node 102a to receive and/or execute a request, build an application based on the request, and/or perform other functions described herein.

At step 203, user device 104 may establish a connection with API gateway 103. For example, user device 104 may establish a first wireless data connection with API gateway 103 to link user device 104 to API gateway 103 (e.g., in preparation for sending a request to develop and/or build an application, and/or performing other functions). In some instances, user device 104 may identify whether or not a connection is established with API gateway 103. If a connection is already established with API gateway 103, user device 104 might not re-establish the connection. If a connection is not yet established API gateway 103, user device 104 may establish the first wireless data connection as described herein.

At step 204, user device 104 may send a request to develop and/or build an application to API gateway 103. For example, user device 104 may send the request to API gateway 103 while the first wireless data connection is established.

At step 205, the API gateway 103 may receive the request. In some instances, the API gateway 103 may receive the request while the first wireless data connection is established. Although the sending and receipt of the request and other information are described at steps 204 and 205, additional information may also be sent to and/or received by the API gateway 103 (e.g., a request to build a plurality of applications, and/or perform other functions) without departing from the scope of the disclosure.

Referring to FIG. 2B, at step 206, the API gateway 103 may establish a connection with distributed autonomous parallel mesh platform 102. For example, API gateway 103 may establish a second wireless data connection with distributed autonomous parallel mesh platform 102 to link API gateway 103 to distributed autonomous parallel mesh platform 102 (e.g., in preparation for sending the request to build an application, and/or performing other functions). In some instances, API gateway 103 may identify whether or not a connection is established with distributed autonomous parallel mesh platform 102. If a connection is already established with distributed autonomous parallel mesh platform 102, API gateway 103 might not re-establish the connection. If a connection is not yet established with distributed autonomous parallel mesh platform 102, the API gateway 103 may establish the second wireless data connection as described herein.

At step 207, API gateway 103 may send the request to build the application to distributed autonomous parallel mesh platform 102. In some instances, the request may include information related to the application such as a primary software component or package (e.g., a user-interface or front-end package, a back-end package, a queue package, and/or other packages) of the application-to-be-built. In some instances, distributed autonomous parallel mesh platform 102 may use this information to determine which of first node 102a, second node 102b, or third node 103c to designate or configure as the parent node that builds the application, as discussed in more detail at step 209.

Although the below steps are described sequentially, they may be performed in parallel by distributed autonomous parallel mesh platform 102 with respect to the receipt of multiple requests from multiple user devices without departing from the scope of the disclosure.

At step 208, the distributed autonomous parallel mesh platform 102 may receive the request. For example, the distributed autonomous parallel mesh platform 102 may receive the request via the communication interface 113 and while the second wireless data connection is established. In some instances, the distributed parallel mesh module 112a may receive the request.

At step 209, the distributed autonomous parallel mesh platform 102 may identify a parent node. In some instances, a parent node, such as first node 102a, may be preconfigured by distributed autonomous parallel mesh platform 102 as the parent node at either of steps 201 or 202. In some instances, the parent node may be identified based on the request from user device 104. For example, if a front-end package is stored at the node database 115b of first node 102a, and the request includes information indicating a primary software component/package of the build is the front-end package, then the distributed autonomous parallel mesh platform 102 may determine the first node 102a to designate or configure as the parent node for building the application.

In some instances, distributed parallel mesh module 112a and/or intelligent engine 112d may use the smart contract generated by smart contract module 112c to identify the parent node by matching the primary software component/package in the request to a node with that package, which was previously recorded in the smart contract. In some instances, multiple parent nodes may be identified based on multiple requests or a request with multiple primary software components/packages. In some instances, API gateway 103 may identify the parent node based on the information in the request at step 207, and send the request directly to the parent node.

In some instances, a parent node may be identified using a trusted process, as discussed in step 224. In some instances, a parent node may be identified based on load-balancing, as discussed in step 224.

At step 210, distributed autonomous parallel mesh platform 102 may identify one or more child nodes. In some instances, distributed autonomous parallel mesh platform 102 may use the smart contract that was generated in step 202 to identify the one or more child nodes. For example, second node 102b and third node 102c may be identified as child nodes based on their containing dependency packages necessary for the parent node, e.g., first node 102a, to execute the request and build the application. For example, if the first node 102a depends on second node 102b's back-end package and/or third node 102c's queue package, distributed autonomous parallel mesh platform 102 may use the smart contract, which contains a record of the relationships between dependency information across the mesh of nodes, to make this determination and identify second node 102b and third node 102c as child nodes. In some instances, distributed autonomous parallel mesh platform 102 may detect missing dependency packages at the one or more child nodes. In some instances, first node 102a may use its smart sub-contract that was generated by smart sub-contract module 115c to make a similar identification.

Referring to FIG. 2C, at step 211, distributed autonomous parallel mesh platform 102 may establish a connection between the parent node and the one or more child nodes. For example, distributed autonomous parallel mesh platform 102 may direct the nodes to establish a connection between each other, such as, for example, between first node 102a, the parent node, and second node 102b and third node 102c as the child nodes. For example, a connection may be established using communication interface 116 for first node 102a, and an equivalent communication interface for second node 102b and third node 102c. In doing so, the child nodes, e.g., second node 102b and third node 102c may prepare to send virtual copies of relevant dependency packages to the parent node, e.g., first node 102a. If a connection is already established between the parent nodes and child nodes, distributed autonomous parallel mesh platform 102 might not re-establish the connection. If a connection is not yet established, distributed autonomous parallel mesh platform 102 may establish the connection as described herein.

At step 212, distributed autonomous parallel mesh platform 102 may direct the one or more child nodes to transmit virtual copies of dependency packages to the parent node. For example, second node 102b and third node 102c, as the child nodes, may be directed by distributed autonomous parallel mesh platform 102 to transmit virtual copies of dependency packages based on the smart contract, to first node 102a, the parent node. For example, if first node 102a requires a dependency package located at one or more of the child nodes, such as second node's 102b second package, or third node's 102c third package, distributed autonomous parallel mesh platform 102 may direct second node 102b and/or third node 102c to transmit a virtual copy of the respective packages to the first node 102a. In some instances, the transmission of the virtual copies may happen automatically.

At step 213, the one or more child nodes, in response to being directed by the distributed autonomous parallel mesh platform 102, may transmit virtual copies of dependency packages (e.g., second node 102b transmits a virtual copy of the second package, third node 102c transmits a virtual copy of the third package) to the parent node (first node 102a) using the previously established connection from step 211. In some instances, the child nodes may transmit the respective dependency package from a node database associated with the one or more child nodes, such as a database similar to database 115b of first node 102a.

Referring to FIG. 2D, at step 214, the parent node may receive the virtual copies that were transmitted by the child nodes in step 213. At step 215, parent nodes may store the virtual copies. For example, the parent node, e.g., the first node 102a, may store the virtual copies at the node database 115b.

At step 216, the parent node may execute the request to build the application. In some instances, distributed autonomous parallel mesh platform 102 may direct the parent node to execute the request. In some instances, the parent node may automatically execute the request and build the application. For example, first node 102a, as the parent node, may build an application after acquiring the necessary dependency packages (e.g., the second package and/or the third package) received at step 214.

At step 217, distributed autonomous parallel mesh platform 102 may detect that the application was successfully built. In some instances, distributed autonomous parallel mesh platform 102 may detect the successful build automatically. In some instances, first node 102a may send an indication to distributed autonomous parallel mesh platform 102 notifying distributed autonomous parallel mesh platform 102 that the application was successfully built.

Referring to FIG. 2E, at step 218, distributed autonomous parallel mesh platform 102 may automatically publish the application. For example, distributed autonomous parallel mesh platform 102 may publish the application locally at the distributed parallel mesh database 112b. In some instances, distributed autonomous parallel mesh platform 102 may publish the application at a server or database, such as an enterprise server that may be accessed by user device 104 and/or other user devices. In this manner, user device 104 or any other computing device may access the application and/or otherwise use the application.

At step 219, distributed autonomous parallel mesh platform 102 may send a notification to API gateway 103 indicating that the application was successfully built and/or published. In some instances, distributed autonomous parallel mesh platform 102 may send the notification to API gateway via the communication interface 113 and while the second wireless data connection is established.

At step 220, API gateway 103 may receive the notification. For example, API gateway 103 may receive the notification from distributed autonomous parallel mesh platform 102 via the communication interface 113 and while the second wireless data connection is established.

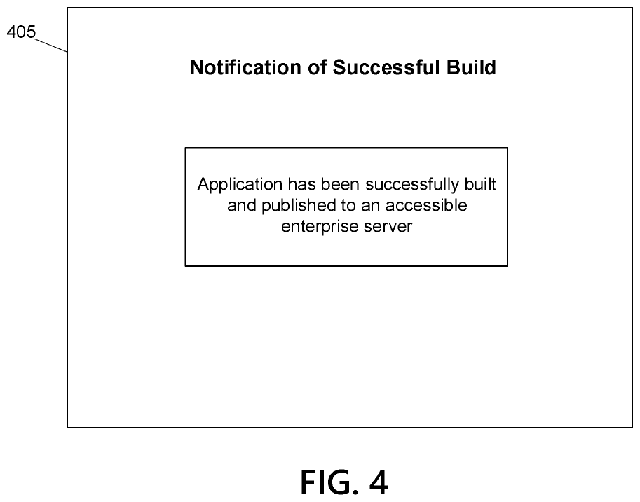

At step 221, API gateway 103 may send the notification to user device 104. In some instances, API gateway 103 may send the notification to user device 104 while the first wireless data connection is established. At step 222, the user device 104 may receive the notification via the first wireless data connection. The notification may include one or more commands, that, when received by the user device 104, direct the user device 104 to display the notification (e.g., on a display of user device 104). In some instances, user device 104 may display a graphical user interface similar to graphical user interface 405, which is illustrated in FIG. 4. For example, the notification may include information, such as, for example, a notification that the application was successfully built and/or published. The notification may include other information without departing from the scope of the disclosure. In some instances, the notification may be sent from distributed autonomous parallel mesh platform 102 directly to user device 104.

At step 223, distributed autonomous parallel mesh platform 102 may remove dependency packages from the parent node. For example, distributed autonomous parallel mesh platform 102 may direct first node 102a, the parent node, to remove and/or otherwise delete the dependency package/packages (e.g., the second package and/or the third package) it previously received from the child nodes in step 214. In some instances, the dependency packages may be removed automatically upon detection that the application was successfully built in step 217. In some instances, a pre-configured time-to-live (TTL) may be used by distributed autonomous parallel mesh platform 102 to direct the parent node to remove the dependency packages after the TTL has expired.

Referring to FIG. 2F, at step 224, distributed autonomous parallel mesh platform 102 may update the node configuration. For example, the parent node, first node 102a, may be demoted to a child node, and one of second node 102b or third node 102c may be promoted to be a new parent node. In some instances, a second request from user device 104 may determine that second node 102b is to be the new parent node based on information in the second request such as the primary software component/package being the back-end package that is located at second node 102b. In some instances, a new node or nodes may be created and added to the node configuration by distributed autonomous parallel mesh platform 102.

In some instances, the promoting and/or demoting of nodes may be based on a trusted process. For example, a parent node may, based on determining that a child node has correctly transmitted virtual copies of dependency packages during a previous request or requests, make the child node a parent node. In some instances, a parent node may use a threshold representing the number of times a child node has correctly transmitted virtual copies of dependency packages to a parent node, to determine that a child node has exceeded the threshold and may become a parent node.

In some instances, a parent node may determine that a child node is not to be trusted as a parent node based on suspicious activity at the child node and/or a lack of communication between the parent node and the child node. For example, a parent node may, based on determining that a child node has incorrectly transmitted virtual copies of dependency packages during a previous request or requests, not allow the child node to become a parent node. In some instances, a parent node may use a threshold representing the number of times a child node has correctly transmitted virtual copies of dependency packages to determine that a child node has not exceeded the threshold and may not become a parent node. The process of promoting and/or demoting nodes may happen dynamically and/or without direction from distributed autonomous parallel mesh platform 102 without departing from the scope of the disclosure.

Additionally or alternatively, the promoting and/or demoting of nodes may be based on load-balancing, so that the computing resources of the mesh of nodes (e.g., first node 102a, second node 102b, and/or third node 102c) may be allocated properly so as to minimize use of computing resources. For example, a parent node, such as first node 102a, may determine that a child node, such as node 102b, may exceed a computing resource threshold (e.g., greater than 50% available computing power) necessary to be a parent node and execute future requests or support the execution of a current request. In some instances, a parent node, such as first node 102a, may determine that a child node, such as node 102b, may not exceed a computing resource threshold (e.g., at or less than 50% available computing power) necessary to be a parent node. The computing resource threshold may be configured using different methods (e.g., based on central processing unit (CPU) utilization, available memory, etc) without departing from the scope of the disclosure. In some instances, distributed autonomous parallel mesh platform 102 may use load-balancing to promote and/or demote nodes. In some instances, one or more nodes may be ranked based on availability and/or computing resources in order to identify a parent node.

In some instances, new nodes may be created and/or added to the node configuration by distributed autonomous parallel mesh platform 102 and/or a parent node, such as first node 102a. In doing so, requests from multiple user devices may be executed in parallel with multiple nodes acting as parent nodes, performing the steps of 209-224 as needed.

At step 225, distributed autonomous parallel mesh platform 102 may update the smart contract. In some instances, the primary smart contract may be updated by smart contract module 112c. In some instances, the smart contract may be dynamically updated based on the updated node configuration performed in step 224. In some instances, the smart sub-contracts of any of first node 102a, second node 102b, and/or third node 102c may be dynamically updated based on the updating of the primary smart contract and/or updated after the application is built.

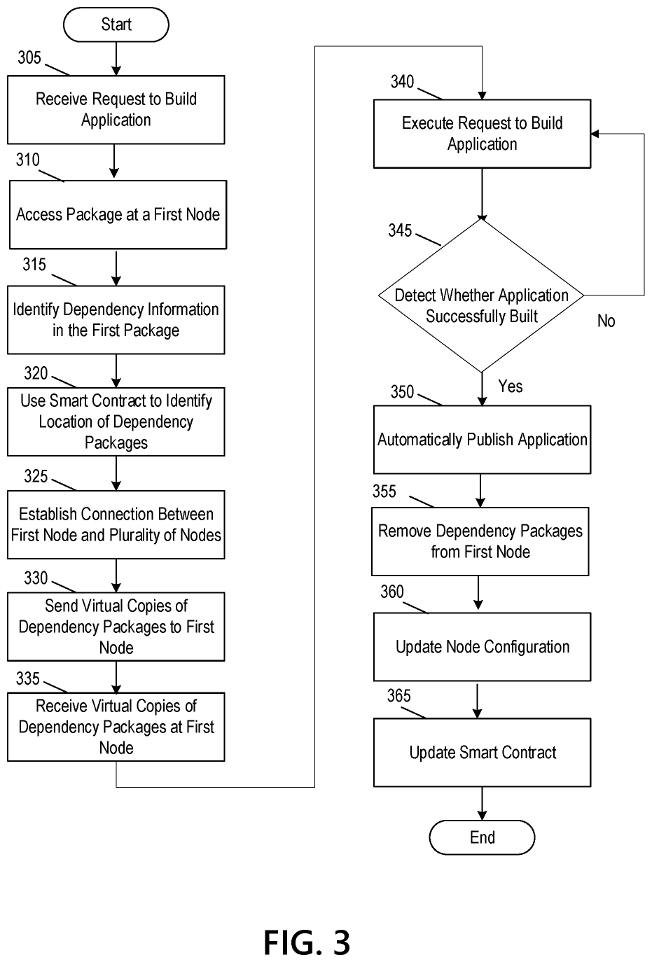

FIG. 3 depicts an illustrative method for implementing an intelligent system for autogenerating a disseminated virtual environment setup using parallel mesh oriented logical programming in accordance with one or more example embodiments. At step 305, a computing platform having at least one processor, a communication interface, and memory may receive a request to build an application. At step 310, the computing platform may access a first package at a first node that corresponds to the application.

At step 315, the computing platform may identify dependency information in the first package. At step 320, the computing platform may use a smart contract to identify a plurality of nodes that contain the dependency packages identified by the dependency information. At step 325, the computing platform may establish a connection between the first node and the plurality of nodes.

At step 330, the computing platform may cause virtual copies of the dependency packages from the plurality of nodes to be sent to the first node. At step 335, the computing platform may receive the virtual copies of the dependency packages at the first node. At step 340, the computing system may execute the request and build the application at the first node.

At step 345, the computing platform may detect whether the application was successfully built at the first node. If the application was not successfully built, the computing platform may proceed to step 340 and re-execute the request to build the application at the first node. If the application was successfully built, the computing platform may proceed to step 350. At step 350, the computing platform may automatically publish the application to an enterprise server that the user device 104 may access.

At step 355, the computing platform may remove the virtual copies of the dependency packages from the first node. At step 360, the computing platform may update the node configuration. At step 365, the computing platform may update the smart contract.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive, from a user device, a request to build an application;
access, at a first node and based on the request to build the application, a first package corresponding to the application;
identify dependency information in the first package, wherein the dependency information indicates a plurality of dependency packages the first node requires to build the application;
identify, using a smart contract that corresponds to the dependency information, a plurality of nodes that contain the plurality of dependency packages;
establish a connection between the first node and the plurality of nodes;
send one or more commands to the plurality of nodes that, when received by the plurality of nodes, direct the plurality of nodes to send virtual copies of the plurality of dependency packages to the first node;
receive, by the first node, the dependency packages;
execute, by the first node, the request to build the application, wherein executing the request to build the application comprises building the application;
detect that the application was successfully built; and
based on detecting that the application was successfully built, automatically publish the application to an enterprise server for access by the user device.

2. The computing platform of claim 1, wherein the memory stores computer-readable instructions that, when executed by the at least one processor, further cause the computing platform to:
send, to the user device, a notification indicating that the application was successfully built and one or more commands directing the user device to display the notification, wherein sending the one or more commands directing the user device to display the notification causes the user device to display the notification.

3. The computing platform of claim 1, wherein the request is received by the computing platform through an application programming interface (API) gateway.

4. The computing platform of claim 1, wherein the memory stores computer-readable instructions that, when executed by the at least one processor, further cause the computing platform to:
generate the smart contract based on relationships between the first package at the first node and the dependency packages at the plurality of nodes.

5. The computing platform of claim 1, wherein the memory stores computer-readable instructions that, when executed by the at least one processor, further cause the computing platform to:
detect missing dependency packages at one or more of the plurality of nodes.

6. The computing platform of claim 1, wherein the first node is a parent node and the plurality of nodes are child nodes.

7. The computing platform of claim 6, wherein the memory stores computer-readable instructions that, when executed by the at least one processor, further cause the computing platform to:
determine that the first node is the parent node based on information in the request to build the application indicating the first package at the first node is a primary software component of the application.

8. The computing platform of claim 6, wherein the memory stores computer-readable instructions that, when executed by the at least one processor, further cause the computing platform to:
demote the first node to a child node;
promote a second node of the plurality of nodes to be the parent node; and
dynamically reconfigure relationships between the first node, the second node, and a remainder of the plurality of nodes based on the demoting and promoting.

9. The computing platform of claim 8, wherein the demoting is based on the first node not exceeding a computing resource threshold required to support a future request.

10. The computing platform of claim 8, wherein the promoting is based on the second node exceeding a computing resource threshold required to support a future request.

11. The computing platform of claim 8, wherein the memory stores computer-readable instructions that, when executed by the at least one processor, further cause the computing platform to:
update the smart contract based on the reconfiguring of the relationships between the first node, the second node, and the remainder of the plurality of nodes.

12. The computing platform of claim 11, wherein the memory stores computer-readable instructions that, when executed by the at least one processor, further cause the computing platform to:
use the second node to execute a second request from the user device, wherein executing the second request comprises building a second application at the second node.

13. A method comprising:
at a computing platform comprising at least one processor, a communication interface, and memory:
receiving a request to build an application from a user device;
accessing, at a first node and based on the request to build the application, a first package;
identifying dependency information in the first package, wherein the dependency information indicates a plurality of dependency packages the first node requires to build the application;
identifying, using a smart contract that corresponds to the dependency information, a plurality of nodes that contain the dependency packages;
establishing a connection between the first node and the plurality of nodes;
sending one or more commands to the plurality of nodes, that when received by the plurality of nodes, direct the plurality of nodes to send virtual copies of the dependency packages to the first node;
receiving, by the first node, the dependency packages;
executing, by the first node, the request to build the application, wherein executing the request to build the application comprises building the application;
detecting that the application was successfully built; and
based on detecting that the application was successfully built, automatically publishing the application to an enterprise server that the user device may access.

14. The method of claim 13, further comprising generating the smart contract based on relationships between the package at the first node and the dependency information at the plurality of nodes.

15. The method of claim 13, further comprising detecting missing dependency packages at one or more of the plurality of nodes.

16. The method of claim 13, wherein the first node is a parent node and the plurality of nodes are child nodes.

17. The method of claim 16, further comprising determining that the first node is the parent node based on information in the request to build the application indicating the package at the first node is a primary software component of the application.

18. The method of claim 17, further comprising:
demoting the first node to a child node;
promoting a second node of the plurality of nodes to be the parent node; and
dynamically reconfiguring relationships between the first node, the second node, and a remainder of the plurality of nodes.

19. The method of claim 18, further comprising updating the smart contract based on the reconfiguring of the relationships between the first node, the second node, and the remainder of the plurality of nodes.

20. One or more non-transitory computer-readable media storing instructions that, when executed by a computing platform comprising at least one processor, a communication interface, and memory, cause the computing platform to:
receive, from a user device, a request to build an application;
access, at a first node and based on the request to build the application, a first package corresponding to the application;
identify dependency information in the first package, wherein the dependency information indicates a plurality of dependency packages the first node requires to build the application;
identify, using a smart contract that corresponds to the dependency information, a plurality of nodes that contain the plurality of dependency packages;
establish a connection between the first node and the plurality of nodes;
send one or more commands to the plurality of nodes, that when received by the plurality of nodes, direct the plurality of nodes to send virtual copies of the plurality of dependency packages to the first node;
receive, by the first node, the dependency packages;
execute, by the first node, the request to build the application, wherein executing the request to build the application comprises building the application;
detect that the application was successfully built; and
based on detecting that the application was successfully built, automatically publish the application to an enterprise server for access by the user device.
